(19) United States
(12) Patent Application Publication
(10) Pub. No.: US 2010/0154775 A1
(43) Pub. Date: Jun. 24, 2010

(54) TUBE BURNER WITH ADJUSTABLE LENGTH

(75) Inventor: Christian Wayne Robinson, Kitchener (CA)

Correspondence Address: DARYL W SCHNURR;MILLER THOMSON LLP, ACCELERATOR BUILDING, 295 HAGEY BLVD., SUITE 300, WATERLOO, ON, N2L 6R5, CA

(73) Assignee: Onward Multi-Corp Inc.

(21) Appl. No.: 12/346,572

(22) Filed: Dec. 30, 2008

(30) Foreign Application Priority Data
Dec. 24, 2008 (CA) 2,647,915

(51) Int. Cl. F23D 14/62; A47J 37/07

(52) U.S. Cl. 126/39 E; 431/354

(57) ABSTRACT

A tube burner has an adjustable length with two tubes that telescopingly slide within one another. When adjusted to the desired length, a screw is inserted into the two aligned combustion openings to hold the tubes in a fixed position.

### BACKGROUND OF THE INVENTION

1. Field of the Invention

This invention relates to a tube burner having an adjustable length with a first tube having a second tube slidably mounted therein, the first and second tubes having a plurality of combustion openings along either side thereof. The length of the tube burner is adjustable by sliding the second tube further into or further out of the first tube.

2. Description of the Prior Art

Previous burners are manufactured with a specific length and the length is not adjustable. Tube burners are often used in the after market in the gas barbecue/gas grill field for replacement burners. When replacing a tube burner, it is essential that the replacement burner be of identical length or at least substantially the same length as the tube burner that is being replaced. Businesses that sell replacement tube burners stock burners of different sizes and lengths to ensure that it can provide a replacement burner to a customer that requires a tube burner of a particular length.

### SUMMARY OF THE INVENTION

It is an object of the present invention to provide a tube burner that has an adjustable length so that the burner can be adjusted to replace tube burners of virtually any length within a predetermined range. When the length of the tube burner has been appropriately adjusted, the burner can be fixed at that length by using an appropriate fastener.

A tube burner has an adjustable length and comprises two tubes, being a first tube and a second tube. Each of said tubes has a plurality of combustion openings along either side thereof, the combustion openings in the second tube corresponding to the combustion openings in the first tube. The first tube has a first open end and a closed end, the second tube having two opened ends, being a second open end and a third open end. The first tube and the second tube are sized and shaped so that the third open end of the second tube is telescopingly slidable within the first tube through the first opening. The second tube always at least partially overlaps with the first tube. A fastener maintains the tubes in a fixed position relative to one another with any combustion openings in an area where the tubes overlap being aligned with each other.

### BRIEF SUMMARY OF THE DRAWINGS

FIG. 1 is a perspective view of a tube burner in a fully extended position;

FIG. 2 is a partial perspective view of the tube burner in a retracted position;

FIG. 3 is a side view of the tube burner in a fully extended position;

FIG. 4 is a partial sectional side view of the tube burner in a fully extended position;

FIG. 5 is a partial sectional side view of the tube burner in a retracted position; and

FIG. 6 is a perspective view of an L-shaped mounting bracket.

### DETAILED DESCRIPTION OF A PREFERRED EMBODIMENT

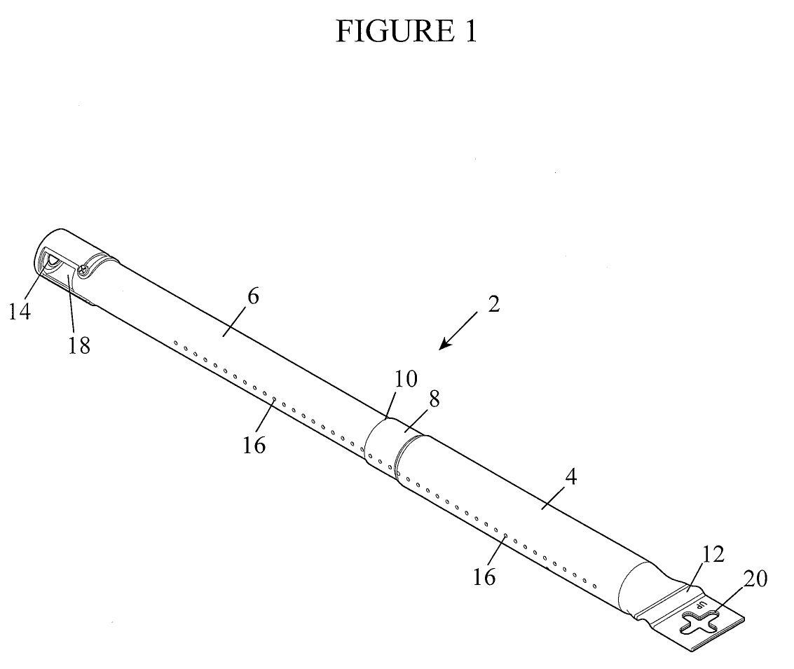

In FIG. 1 there is shown a perspective view of a tube burner 2 having an adjustable length with a first tube 4 and a second tube 6. The second tube is sized and shaped to telescopingly slide within the first tube. The first tube has a neck 8 with a first open end 10 and a closed end 12. The second tube 6 has a second open end 14 and a third open end (not shown in FIG. 1). The tubes 4, 6 are shaped so that the third open end fits within the first open end 10. The first tube 4 and second tube 6 have a plurality of combustion openings 16 along either side thereof (only one side being shown). The combustion openings 16 are equally spaced to one another and the combustion openings on the second tube 6 correspond to the combustion openings on the first tube 4. The combustion openings 16 are preferably equal in size to one another. The second open end 14 is sized to receive a venturi (not shown) and has an inlet opening 18. The closed end 12 has a bracket 20 thereon. The bracket 20 enables the tube burner 2 to be mounted within a gas grill or gas barbecue or any other device (not shown) that is to be heated by the tube burner 2.

When the length of the tube burner 2 is adjusted, the second tube 6 is either inserted further into the first tube 4 to a retracted position to shorten the burner or is moved further out from the first tube 4 from the retracted position to lengthen the tube burner. The tube burner 2 always has an overlap area (not shown in FIG. 1) where the second tube at least partially overlaps with the first tube 4. Retracted position in any position of the tube burner 2 that is retracted from the fully extended position.

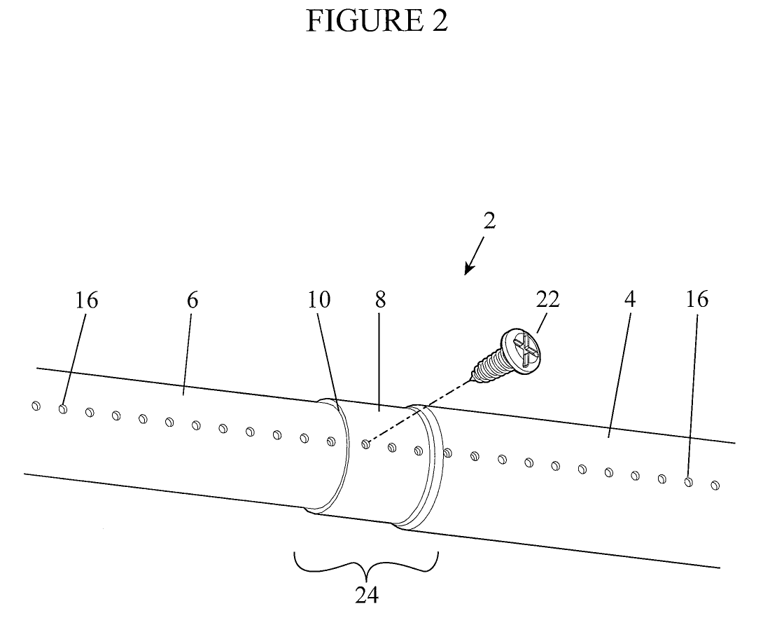

In FIG. 2, the tube burner 2 has been adjusted to a retracted position and a fastener 22 is about to be inserted within an area 24 of overlap between the two tubes 4, 6. The combustion openings 16 of the two tubes 4, 6 are aligned with one another in the area of overlap. The fastener 22 is inserted into two aligned openings to fix the length of the tube burner 2 in that retracted position. It can be seen that there are six combustion openings 16 that are aligned with one another, the fastener is a screw.

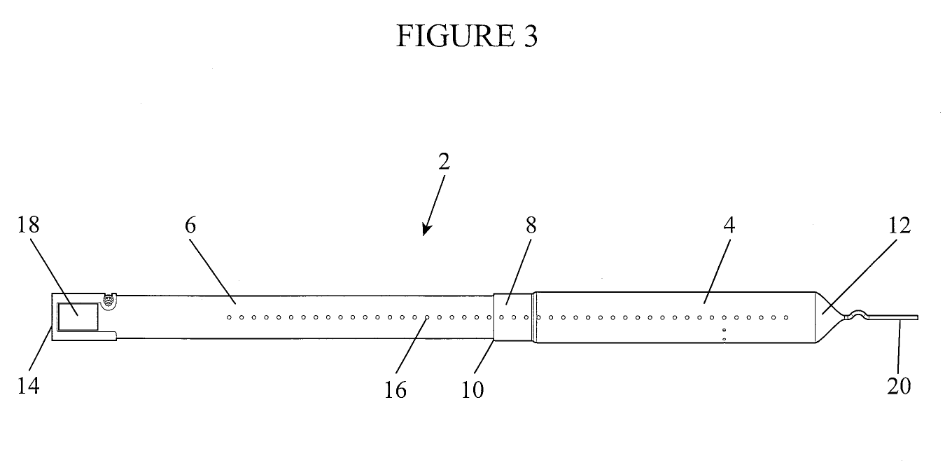

In FIG. 3, there is shown a side view of the tube burner 2, the same reference numerals are used as those used in FIG. 1 for those components that are identical.

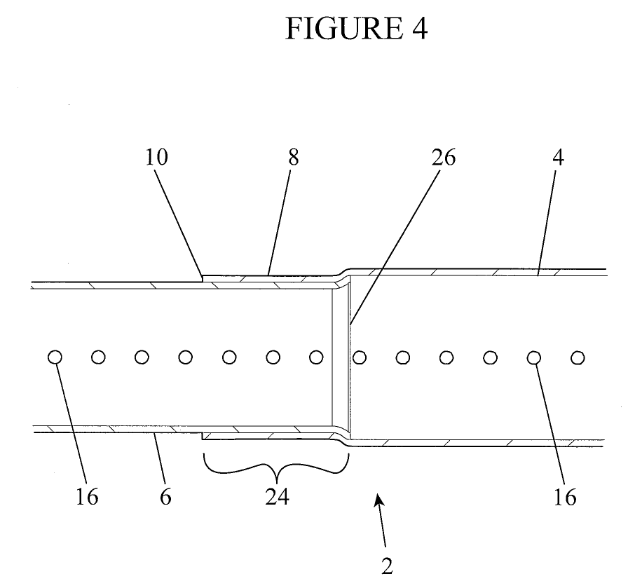

In FIG. 4, there is shown a partial sectional side view of the tube burner 2 in the fully extended position. The tube 6 has a third open end 26 that is located inside the tube 4. The overlap area 24 is three combustion openings 16. The third open end 26 flares outward to conform to a curvature of the neck 8 of the tube 4.

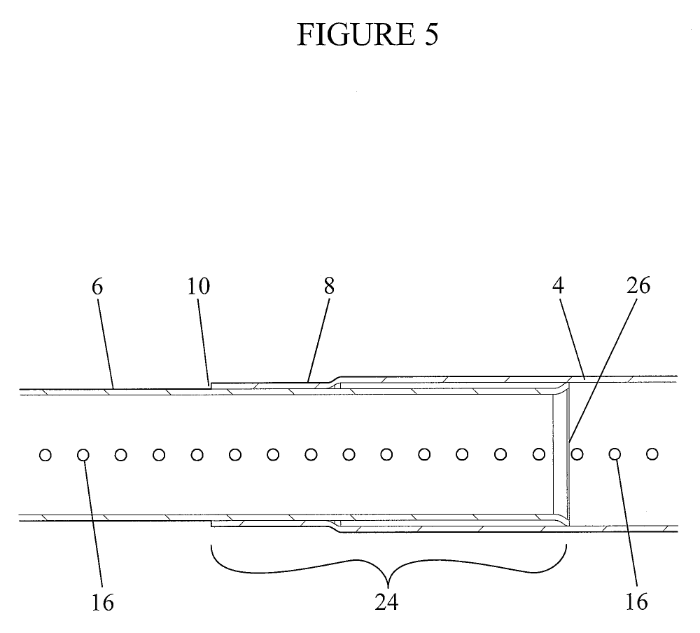

FIG. 5 is similar to FIG. 4 except that the tube burner 2 is in a retracted position and the overlap area 24 is much larger than the overlap area of FIG. 4. The tube 6 is installed into the tube 4 from the closed end 12 before the end 12 is closed. The tube 6 is inserted through the closed end of the tube 4 before the closed end is crimped.

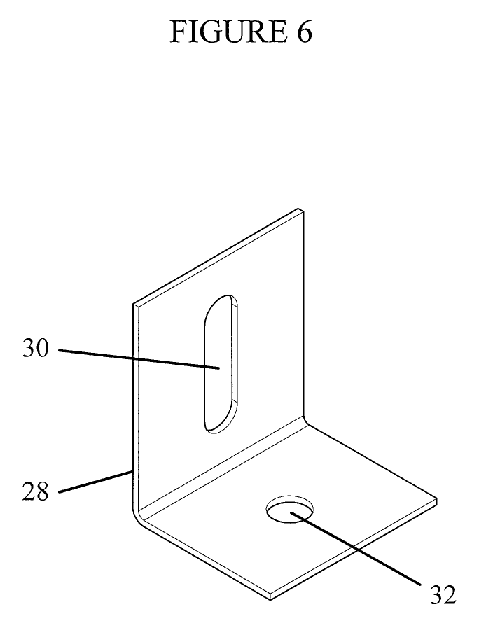

In FIG. 6, there is shown an L-shaped bracket 28 having an oblong opening 30 on one surface thereof and a circular opening 32 on the other surface thereof. The bracket 28 can be affixed to the bracket 20 on the closed end 12 of the second burner tube 4 to hold the tube burner 2 in position within the device to be heated (not shown) between the venturi (not shown) and the bracket 28. The bracket 28 is affixed to the device to be heated.

The length of the tube burner is adjustable within a predetermined range. This allows vendors to stock one tube burner having a particular diameter, which can be retrofitted to heating devices to replace tube burners of various lengths.

I claim:

1. A tube burner having an adjustable length, said tube burner comprising two tubes, being a first tube and a second tube, each of said tubes having a plurality of combustion openings along either side thereof, said combustion openings in said second tube corresponding to said combustion openings in said first tube, said first tube having a first open end and a closed end, said second tube having two open ends, being a second open end and a third open end, said first tube and said second tube being sized and shaped so that a third open end of said second is telescopingly slidable within said first tube through said first opening, said second tube always at least partially overlapping with said first tube, with a removable fastener to maintain said tubes in a fixed position relative to one another with any combustion openings in an area where said tubes overlap being aligned with one another.

2. A tube burner as claimed in claim 1 wherein said fastener extends within two aligned combustion openings, one combustion opening being in a first tube and the other combustion opening being in the second tube.

3. A tube burner as claimed in claim 1 wherein said second open end is shaped to receive a venturi, there being an air inlet opening in said second end.

4. A tube burner as claimed in claim 1 wherein the combustion openings are equally spaced from one another.

5. A tube burner as claimed in claim 4 wherein the combustion openings are substantially the same size.

6. A tube burner as claimed in claim 5 wherein the second tube is substantially longer than the first tube.

7. A tube burner wherein said second tube fits snugly within said first tube.

8. A tube burner wherein said first tube has a neck at said first open end, said neck being narrower than a body of said first tube, said second tube being said to fit within said neck
